(19) United States
(12) Patent Application Publication
(10) Pub. No.: US 2019/0123656 A1
(43) Pub. Date: Apr. 25, 2019

(54) POWER SUPPLY SYSTEM

(71) Applicant: Honda Motor Co.,Ltd., Tokyo (JP)

(72) Inventor: Toshihiro Sone, Saitama (JP)

(73) Assignee: Honda Motor Co.,Ltd., Tokyo (JP)

(21) Appl. No.: 16/135,005

(22) Filed: Sep. 19, 2018

(30) Foreign Application Priority Data
Oct. 19, 2017 (JP) 2017-202905

(51) Int. Cl. H02M 3/34; H02J 7/00; H02M 3/158

(52) U.S. Cl. CPC H02M 3/34; H02J 7/0013; H02J 2001/008; H02M 3/1582; H02M 3/1584; H02J 7/0065

(57) ABSTRACT

A power supply device including a first power supply, a second power supply, a voltage control unit (VCU) stepping up a voltage from an input terminal to an output terminal, and an electronic control unit (ECU) is provided. The VCU includes an upper arm, a lower arm, a reactor having one end connected to the input terminal and the other end connected to a connection midpoint between the upper arm and the lower arm, and a current sensor acquiring a value of a current flowing in the reactor. At startup of the VCU, after performing a startup control that gradually increases a duty ratio of a transistor of the lower arm while turning off a transistor of the upper arm, the ECU performs a normal control that complementarily drives the transistors. During the startup control, the ECU determines whether to terminate the startup control using the acquired current value.

### CROSS-REFERENCE TO RELATED APPLICATION

This application claims the priority benefit of Japan Application No. 2017-202905, filed on Oct. 19, 2017. The entirety of the above-mentioned patent application is hereby incorporated by reference herein and made a part of this specification.

### BACKGROUND

### Technical Field

The disclosure relates to a power supply system including two power supplies and a voltage converter provided between the two power supplies.

### Related Art

Recently, there has been proposed a power supply system of a vehicle, in which two power supplies having different characteristics are connected by a voltage converter and power interchange between these power supplies is enabled (e.g., see Japanese Laid-open No. 2017-41973). FIG. 5 schematically illustrates a configuration of a conventional power supply system 100 including such two power supplies.

The power supply system 100 includes a first power supply 101, a second power supply 102 having different characteristics from the first power supply 101, and a voltage converter 103 provided between the first power supply 101 and the second power supply 102. The voltage converter 103 is a so-called bidirectional direct-current to direct-current (DCDC) converter, may step up an output voltage of the first power supply 101 by acting as a step-up chopper and supply the stepped-up output voltage to the side of the second power supply 102, or may step down an output voltage of the second power supply 102 by acting as a step-down chopper and supply the stepped-down output voltage to the side of the first power supply 101. In the case where the voltage converter 103 acts as the step-up chopper, a switching element of an upper arm 105 of the voltage converter 103 and a switching element of a lower arm 104 of the voltage converter 103 are turned on/off so as to be complementary to each other.

FIG. 6 is a time chart showing an example of control of the switching elements of the upper arm 105 and the lower arm 104 at startup of the voltage converter 103. More specifically, FIG. 6 illustrates changes in various currents in the case where the switching elements of the upper arm 105 and the lower arm 104 are complementarily turned on/off as shown in the uppermost section in FIG. 6 in a state in which the output voltage of the first power supply 101 is lower than the output voltage of the second power supply 102. FIG. 6 shows, in sequence from the lower section, a current ID1 flowing through a diode of the lower arm 104, a current IQ2 flowing through the switching element of the upper arm 105, and a current IL flowing through a reactor. As shown in FIG. 6, in the case where the output voltage of the second power supply 102 is higher than the output voltage of the first power supply 101, at startup of the voltage converter 103, sometimes a large inrush current occurs in various elements of the voltage converter 103 from the side of the second power supply 102 toward the side of the first power supply 101. Accordingly, Japanese Laid-open No. 2009-296847 and Japanese Laid-open No. 2003-70238 show techniques of suppressing the occurrence of inrush current in the power supply system 100 like the above.

Japanese Laid-open No. 2009-296847 discloses a technique in which a voltage converter is provided corresponding to each of two power supplies performing power interchange, and, with respect to one of the voltage converters, the startup of the other voltage converter is delayed. In the other voltage converter, in a serial connection body including an upper arm and a lower arm connected between output terminals, a switching operation of the upper arm is controlled to be stopped for a predetermined period after startup. Accordingly, inrush current can be suppressed from flowing in the other voltage converter.

Japanese Laid-open No. 2003-70238 discloses a technique in which, in a voltage converter provided between power supplies with different voltages, a switching operation of an upper arm is stopped after startup until an output current value of the voltage converter exceeds a predetermined value. By stopping the switching operation of the upper arm over a certain period after startup, inrush current can be suppressed.

Japanese Laid-open No. 2009-296847 and Japanese Laid-open No. 2003-70238 disclose that the flowing of inrush current is suppressed by stopping the switching operation of the upper arm over a certain period after startup of the voltage converter. However, in Japanese Laid-open No. 2009-296847, how to actually set the period over which the switching operation of the upper arm is stopped is not sufficiently discussed.

Meanwhile, Japanese Laid-open No. 2003-70238 discloses that the period over which the switching operation of the upper arm is stopped to suppress inrush current is set based on the output current value of the voltage converter. More in detail, it is disclosed that a current value flowing in an output lead wire of the voltage converter is detected, and based on this detected value, the period over which the switching operation of the upper arm is stopped is determined. However, a phenomenon is exhibited that a rate of change of the current flowing in the output lead wire of the voltage converter varies depending on a potential difference between input and output of the voltage converter. This phenomenon means that a current threshold taken as a determination criterion for avoiding the occurrence of inrush current depends on the potential difference between the input and output. That is, as long as it is intended to determine the period over which the switching operation of the upper arm is stopped based on the current value flowing in the output lead wire of the voltage converter, it is necessary to reset the determination threshold according to the potential difference between the input and output of the voltage converter. Thus, the technique disclosed in Japanese Laid-open No. 2003-70238 is complex when implemented.

The disclosure provides a power supply device capable of effectively suppressing inrush current in a voltage converter after startup and easy to implement.

### SUMMARY

A power supply system (e.g., later-described power supply system S) of the disclosure includes: a first power supply (e.g., later-described first power supply 1); a second power supply (e.g., later-described second power supply 2); a voltage converter (e.g., later-described VCU 3) having an input terminal (e.g., later-described primary terminals 11 and 12) connected to the first power supply and an output terminal (e.g., later-described secondary terminals 21 and 22) connected to the second power supply, the voltage converter stepping up and outputting a voltage from the input terminal to the output terminal; and a control device (e.g., later-described ECU 5) controlling the voltage converter. The voltage converter includes: an upper arm (e.g., later-described upper arm 32) including a switching element (e.g., later-described transistor Q2) having one end connected to a positive electrode of the output terminal; a lower arm (e.g., later-described lower arm 31) including a switching element (e.g., later-described transistor Q1) having one end connected to the upper arm and the other end connected to a negative electrode of the output terminal; a reactor (e.g., later-described reactor L) having one end connected to a positive electrode of the input terminal and the other end connected to a connection midpoint (e.g., later-described connection midpoint 33) between the upper arm and the lower arm; and a reactor current acquisition part (e.g., later-described current sensor 35) acquiring a value of a current flowing in the reactor. At startup of the voltage converter, after performing a startup control (e.g., later-described processing in steps S3 to S8 in FIG. 2) that gradually increases a duty ratio (e.g., later-described duty ratio γ1) of the switching element of the lower arm in a state in which the switching element of the upper arm is turned off, the control device performs a normal control (e.g., later-described processing in step S9 in FIG. 2) that complementarily drives the switching element of the upper arm and the switching element of the lower arm, wherein during execution of the startup control, the control device determines whether to terminate or to continue with the startup control by using the value of the current acquired by the reactor current acquisition part.

### BRIEF DESCRIPTION OF THE DRAWINGS

FIG. 1 illustrates a configuration of a vehicle equipped with a power supply system according to an embodiment of the disclosure.

FIG. 2 is a flowchart illustrating a specific procedure for starting a voltage control unit (VCU) and controlling a secondary side voltage using a step-up function of the VCU.

FIG. 3 illustrates a specific example of a change in a reactor current during execution of a startup control.

FIG. 4 is a time chart showing changes in various currents realized in the case where the VCU is started according to the flowchart of FIG. 2.

FIG. 5 schematically illustrates a configuration of a conventional power supply system including two power supplies.

FIG. 6 is a time chart showing an example of control of switching elements of an upper arm and a lower arm at startup of a voltage converter.

### DESCRIPTION OF THE EMBODIMENTS

In one embodiment of the disclosure, if a length of a period during which the value of the current acquired by the reactor current acquisition part is equal to or less than a current threshold (e.g., later-described current threshold IL_th) set to 0 or a value slightly greater than 0 is equal to or less than a time threshold (e.g., later-described time threshold T_th) set to a value slightly greater than 0 in a duty cycle of the switching element of the lower arm, the control device determines to terminate the startup control.

In one embodiment of the disclosure, if the value of the current acquired by the reactor current acquisition part at the end of a duty cycle of the switching element of the lower arm is greater than a current threshold (e.g., later-described current threshold IL_th) set to a value slightly greater than 0, the control device determines to terminate the startup control.

In one embodiment of the disclosure, the voltage converter includes a smoothing capacitor (e.g., later-described primary smoothing capacitor C1) connected to the positive electrode and a negative electrode of the input terminal, and the reactor current acquisition part is a current sensor (e.g., later-described current sensor 35) that generates a signal corresponding to a current flowing between the positive electrode of the input terminal and the reactor or between the reactor and the connection midpoint.

In one embodiment of the disclosure, the control device sets a duty ratio (e.g., later-described duty ratio γ2) of the switching element of the upper arm in the normal control based on the duty ratio (e.g., later-described duty ratio γ1) of the switching element of the lower arm in the duty cycle during which it is determined to terminate the startup control.

(1) In the power supply system of the disclosure, at startup of the voltage converter, after the startup control that gradually increases the duty ratio of the switching element of the lower arm in the state in which the switching element of the upper arm is turned off is performed, the normal control that complementarily drives the switching element of the upper arm and the switching element of the lower arm is performed. Herein, while the startup control is being performed, since the switching element of the upper arm is maintained off, even if the voltage on the side of the output terminal of the voltage converter is higher than the voltage on the side of the input terminal of the voltage converter, occurrence of inrush current from the side of the second power supply toward the side of the first power supply can be suppressed. Herein, in the startup control, as the duty ratio of the switching element of the lower arm is increased, i.e., as the on-time of the switching element of the lower arm is increased, large current may flow in the reactor from the side of the first power supply to the side of the second power supply; also, inrush current at transition to the normal control can be suppressed. Therefore, in the power supply system of the disclosure, whether to terminate the startup control in execution and transition to the normal control or to continue with the startup control in execution is determined using the value of the current acquired by the reactor current acquisition part in the process during which the duty ratio of the lower arm is gradually increased by the startup control. Accordingly, in the power supply system of the disclosure, the startup control can be terminated and the process can transition to the normal control at a proper timing corresponding to a voltage difference between the side of the input terminal and the side of the output terminal at that moment, i.e., in a state in which the duty ratio of the lower arm is increased to a proper magnitude corresponding to the above voltage difference under the startup control. Thus, the occurrence of inrush current at transition to the normal control can be suppressed. Moreover, since an output current of the voltage converter during the execution of the startup control varies depending on the difference in output voltage between the first power supply and the second power supply at that moment, as in the power supply system in Japanese Laid-open No. 2003-70238, in the case where the time to terminate the startup control is decided based on a comparison between the output current value of the voltage converter and the threshold, it is necessary to properly adjust the threshold according to the difference in output voltage. In contrast, in the power supply system of the disclosure, by using the value of the current acquired by the reactor current acquisition part as described above, without adjusting the threshold using the voltage difference, the time to terminate the startup control can be decided at a proper timing each time.

(2) A current in a direction from the side of the first power supply toward the side of the second power supply is defined as positive current. In the startup control, when the switching element of the lower arm is turned on, the current flowing through the reactor increases in the positive direction; after that, when the switching element of the lower arm is turned off, the current decreases toward 0. Moreover, in the startup control, since the switching element of the upper arm is kept off, the current flowing through the reactor will not become smaller than 0. Herein, in the startup control, when the duty ratio of the switching element of the lower arm is gradually increased, a time at which the current flowing through the reactor decreases to 0 after the switching element of the lower arm is turned off in each duty cycle is delayed. Accordingly, in each duty cycle, the length of the period during which the value of the current acquired by the reactor current acquisition part is equal to or less than the current threshold is suitable as a parameter for determining whether to terminate or to continue with the startup control. In the power supply system of the disclosure, by determining to terminate the startup control in the case where the length of such period is equal to or less than the time threshold set to a value slightly greater than 0, the startup control can be terminated at a proper timing so that no inrush current occurs at transition to the normal control.

(3) In the power supply system of the disclosure, if the value of the current acquired by the reactor current acquisition part at the end of the duty cycle of the switching element of the lower arm is greater than the current threshold set to a value slightly greater than 0, it is determined to terminate the startup control. Accordingly, even if accuracy of the value of the current acquired by the reactor current acquisition part is taken into consideration, the current flowing through the reactor will not increase in the negative direction immediately after the transition to normal control. Thus, inrush current can be more reliably suppressed. Moreover, in the power supply system of the disclosure, there is an advantage that, since the time to terminate the startup control is determined using the value of the current acquired at the end of the duty cycle, operation load is reduced as compared to the disclosure in the above (2) in which it is necessary to monitor a history of the value of the current.

(4) In the power supply system of the disclosure, as the reactor current acquisition part, a current sensor generating a signal corresponding to a current flowing between the positive electrode of the input terminal connected to the smoothing capacitor and the reactor or between the reactor and the connection midpoint is used. Accordingly, since the value of the current flowing through the reactor can be accurately acquired, the startup control can be terminated at a proper timing so that no inrush current occurs at the transition to the normal control.

(5) In the power supply system of the disclosure, based on the duty ratio of the switching element of the lower arm in the duty cycle during which it is determined to terminate the startup control, the duty ratio of the switching element of the upper arm in the normal control is set. Accordingly, the occurrence of inrush current immediately after the transition to the normal control can be more reliably suppressed.

Hereinafter, one embodiment of the disclosure is explained with reference to the drawings.

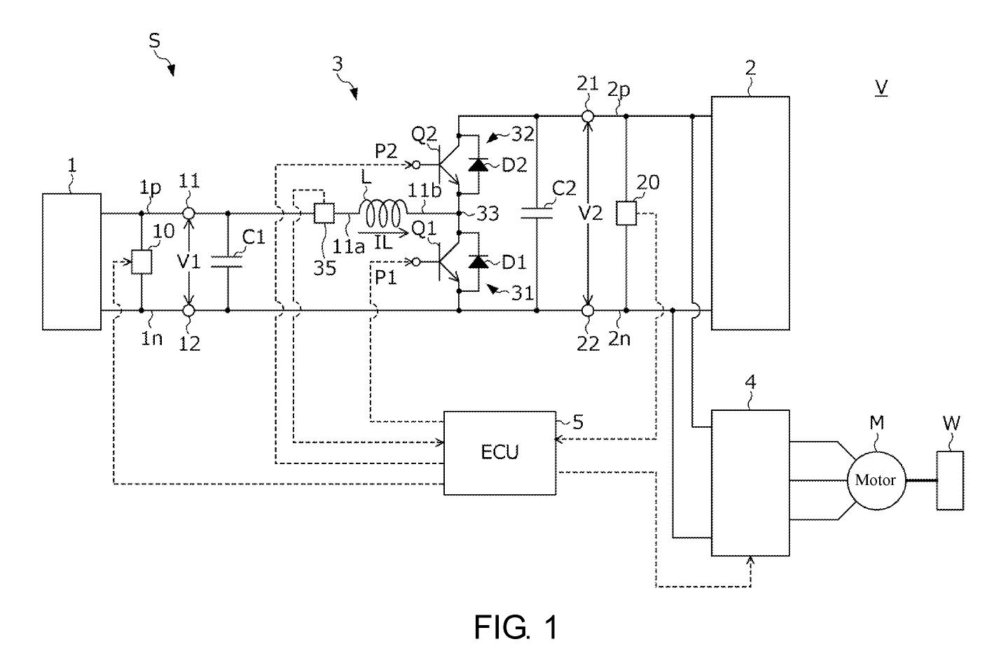

FIG. 1 illustrates a configuration of a vehicle V equipped with a power supply system S according to the present embodiment. Moreover, in the present embodiment, a so-called electric car including two power supplies and a voltage converter provided between the two power supplies is illustrated as an example of the vehicle V. However, the disclosure is not limited thereto. A power supply system according to the disclosure is applicable not only to an electric car but also to any kind of vehicle, such as a hybrid vehicle or a fuel cell vehicle or the like, as long as the vehicle includes two or more power supplies and a voltage converter provided between the power supplies.

The vehicle V includes the power supply system S, a motor M, and a driving wheel W. The motor M mainly generates power for running the vehicle V. The motor M is connected to the driving wheel W. A torque generated by the motor M due to a supply of electric power from the power supply system S to the motor M is transmitted to the driving wheel W via a power transmission mechanism (not illustrated), causing the driving wheel W to rotate and causing the vehicle V to travel. In addition, the motor M functions as an electrical generator during regenerative deceleration of the vehicle V. The electric power generated by the motor M is charged to a first power supply 1 and a second power supply 2 (both described later) included in the power supply system S.

The power supply system S includes the first power supply 1, the second power supply 2, a voltage converter 3 (hereinafter, the abbreviation “VCU (voltage control unit) 3” is used), an inverter 4, and an electronic control unit 5 (hereinafter, the abbreviation “ECU 5” is used) controlling the VCU 3 and the inverter 4.

The first power supply 1 is a direct-current (DC) power supply outputting direct current, wherein a positive electrode and a negative electrode of the first power supply 1 are respectively connected to a primary positive electrode terminal 11 and a primary negative electrode terminal 12 (hereinafter collectively called “primary terminals 11 and 12”) of the VCU 3 via a first positive electrode power line 1p and a first negative electrode power line 1n (hereinafter collectively called “first power lines 1p and 1n”). The first power supply 1 is configured by including a dischargeable and rechargeable power storage device such as a secondary battery or a capacitor or the like, and a contactor or the like electrically connecting or disconnecting the power storage device and the first power lines 1p and 1n.

The second power supply 2 is a DC power supply outputting direct current, wherein a positive electrode and a negative electrode of the second power supply 2 are respectively connected to a secondary positive electrode terminal 21 and a secondary negative electrode terminal 22 (hereinafter collectively called “secondary terminals 21 and 22”) of the VCU 3 via a second positive electrode power line 2p and a second negative electrode power line 2n (hereinafter collectively called “second power lines 2p and 2n”). The second power supply 2 is configured by including a dischargeable and rechargeable power storage device such as a secondary battery or a capacitor or the like, and a contactor or the like electrically connecting or disconnecting the power storage device and the second power lines 2p and 2n. Moreover, in the case where the vehicle V is a fuel cell vehicle, for the second power supply 2, a fuel cell stack is used in place of the power storage device.

The inverter 4 is, for example, a pulse width modulated (PWM) inverter including a bridge circuit composed of a plurality of bridge-connected switching elements (e.g., insulated-gate bipolar transistors (IGBTs)), and has a function of converting DC power and alternate-current (AC) power. The inverter 4 is connected to the second power lines 2p and 2n on a DC input/output side of the inverter 4, and connected to a U-phase coil, a V-phase coil and a W-phase coil of the motor M on an AC input/output side of the inverter 4.

The inverter 4 is composed by bridge-connecting a high-side U-phase switching element and a low-side U-phase switching element connected to the U-phase of the motor M, a high-side V-phase switching element and a low-side V-phase switching element connected to the V-phase of the motor M, and a high-side W-phase switching element and a low-side W-phase switching element connected to the W-phase of the motor M for each phase. By turning on/off the switching elements of the above phases in accordance with a gate driving signal generated from a gate drive circuit of the ECU 5 at a predetermined timing, the inverter 4 may convert the DC power supplied from the second power lines 2p and 2n into AC power and supply it to the motor M, or may convert the AC power supplied from the motor M into DC power and supply it to the second power lines 2p and 2n.

A primary voltage sensor 10 is provided in the first power lines 1p and 1n, for detecting a voltage between the primary terminals 11 and 12 of the VCU 3 and transmitting a signal corresponding to the detected value to the ECU 5. In the following, the voltage detected by the primary voltage sensor 10, i.e., the voltage between the primary terminals 11 and 12 of the VCU 3, is also called “primary-side voltage V1.” Moreover, the primary-side voltage V1 is basically equal to an output voltage of the first power supply 1.

A secondary voltage sensor 20 is provided in the second power lines 2p and 2n, for detecting voltage between the secondary terminals 21 and 22 of the VCU 3 and transmitting a signal corresponding to the detected value to the ECU 5. In the following, the voltage detected by the secondary voltage sensor 20, i.e., the voltage between the secondary terminals 21 and 22 of the VCU 3, is also called “secondary-side voltage V2.” Moreover, the secondary-side voltage V2 is basically equal to an output voltage of the second power supply 2.

The VCU 3 is a so-called bidirectional DC-DC converter configured by combining a lower arm 31 having a transistor Q1 as a switching element, an upper arm 32 having a transistor Q2 as a switching element, a reactor L, a primary smoothing capacitor C1, a secondary smoothing capacitor C2, a current sensor 35, the primary terminals 11 and 12, and the secondary terminals 21 and 22.

An emitter of the transistor Q1 of the lower arm 31 is connected to the secondary negative electrode terminal 22, and a collector of the transistor Q2 of the upper arm 32 is connected to the secondary positive electrode terminal 21. In addition, a collector of the transistor Q1 and an emitter of the transistor Q2 are connected at a connection midpoint 33. In addition, antiparallel diodes D1 and D2 are respectively connected to the transistors Q1 and Q2. A forward direction of the antiparallel diode D1 is a direction from the connection midpoint 33 toward the secondary positive electrode terminal 21, and a forward direction of the antiparallel diode D2 is a direction from the secondary negative electrode terminal 22 toward the connection midpoint 33.

For the transistors Q1 and Q2, a power bipolar transistor, an IGBT, a power metal oxide semiconductor (MOS) transistor or the like may be used. A switching operation of the transistor Q1 is controlled in accordance with a gate driving signal P1 generated from the gate drive circuit of the ECU 5 at a predetermined timing. In addition, a switching operation of the transistor Q2 is controlled in accordance with a gate driving signal P2 generated from the gate drive circuit of the ECU 5 at a predetermined timing.

The reactor L is connected between the primary positive electrode terminal 11 and the connection midpoint 33. The primary smoothing capacitor C1 is connected between the primary positive electrode terminal 11 and the primary negative electrode terminal 12. The secondary smoothing capacitor C2 is connected between the secondary positive electrode terminal 21 and the secondary negative electrode terminal 22.

The current sensor 35 is provided in a first conductor section 11a connecting the primary positive electrode terminal 11 with one end of the reactor L, and transmits a detection signal corresponding to a current flowing through the first conductor section 11a to the ECU 5. Moreover, the current sensor 35 may be provided in a second conductor section 11b connecting the other end of the reactor L with the connection midpoint 33, and may transmit a detection signal corresponding to a current flowing through the second conductor section 11b to the ECU 5. In the following, a current detected by the current sensor 35, i.e., a current flowing through the reactor L is also called a reactor current IL. In addition, a direction of the reactor current IL from the first power supply 1 toward the second power supply 2 is defined as positive direction. In addition, although the current sensor 35 may be interposed in the middle of a conductor section through which a current to be measured flows, like a conventional ammeter, the current sensor 35 may also be provided so as to surround the conductor section through which the current to be measured flows, like a clamp type ammeter using a Hall element.

The VCU 3 configured as above has a step-up function of stepping up and outputting a voltage from the primary terminals 11 and 12 to the secondary terminals 21 and 22 by being operated as a step-up chopper by the gate driving signals P1 and P2 from the ECU 5, and a step-down function of stepping down and outputting a voltage from the secondary terminals 21 and 22 to the primary terminals 11 and 12 by being operated as a step-down chopper by the gate driving signals P1 and P2 from the ECU 5.

The ECU 5 is a microcomputer responsible for controlling travel of the vehicle V, more specifically, for controlling the VCU 3 and the inverter 4.

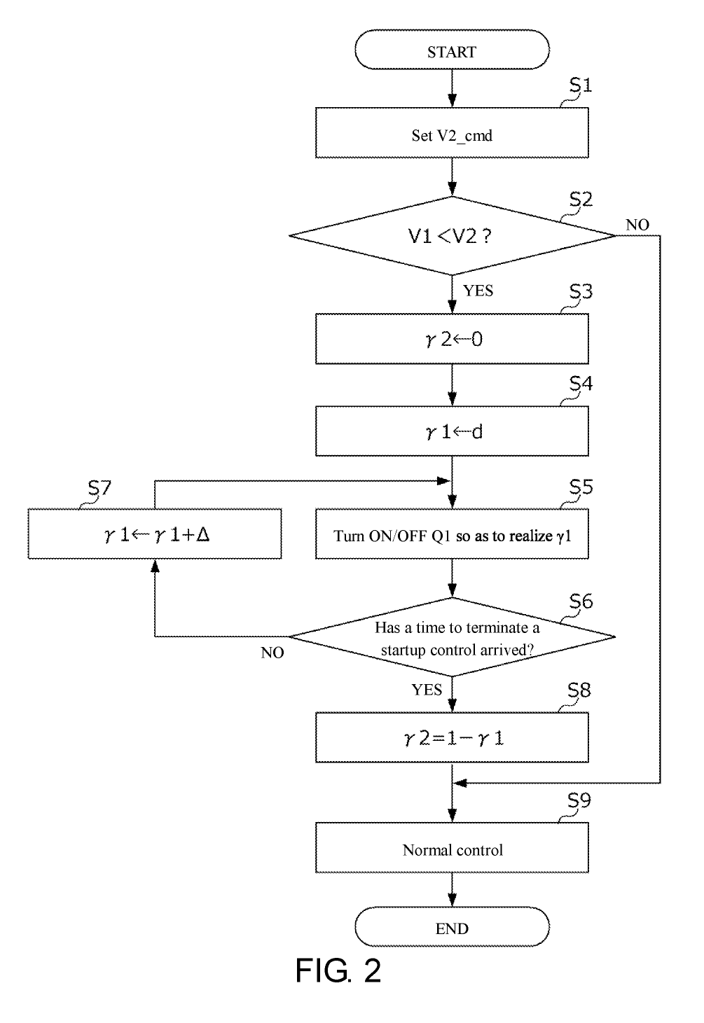

FIG. 2 is a flowchart illustrating a specific procedure for starting the VCU 3 in the ECU 5 and controlling the secondary-side voltage V2 to be a predetermined target secondary voltage V2_cmd by using the step-up function of the VCU 3. The flowchart of FIG. 2 is implemented in the ECU 5 according to occurrence of a startup request of the VCU 3 in a state in which the VCU 3 is stopped, i.e., a state in which the transistors Q1 and Q2 are turned off.

Firstly, in step S1, the ECU 5 sets the target secondary voltage V2_cmd with respect to the secondary-side voltage V2. The target secondary voltage V2_cmd is set by, for example, an operation in the ECU 5 according to a power load ratio or the like between the first power supply 1 and the second power supply 2.

Next, in step S2, the ECU 5 compares the primary-side voltage V1 detected by the primary voltage sensor 10 with the secondary-side voltage V2 detected by the secondary voltage sensor 20, and determines whether or not the primary-side voltage V1 is lower than the secondary-side voltage V2 (V1<V2).

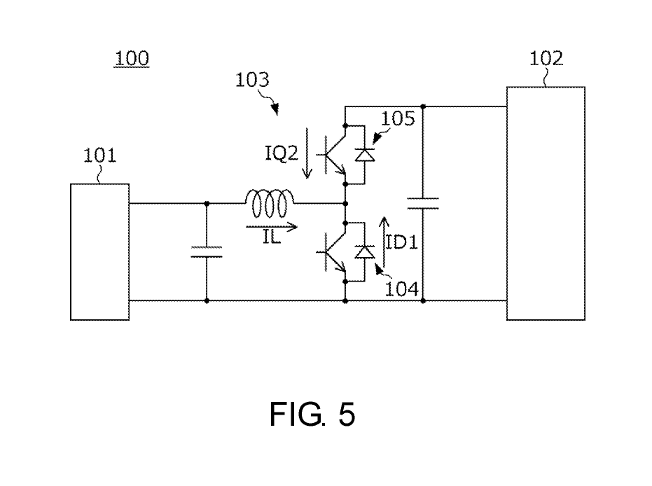

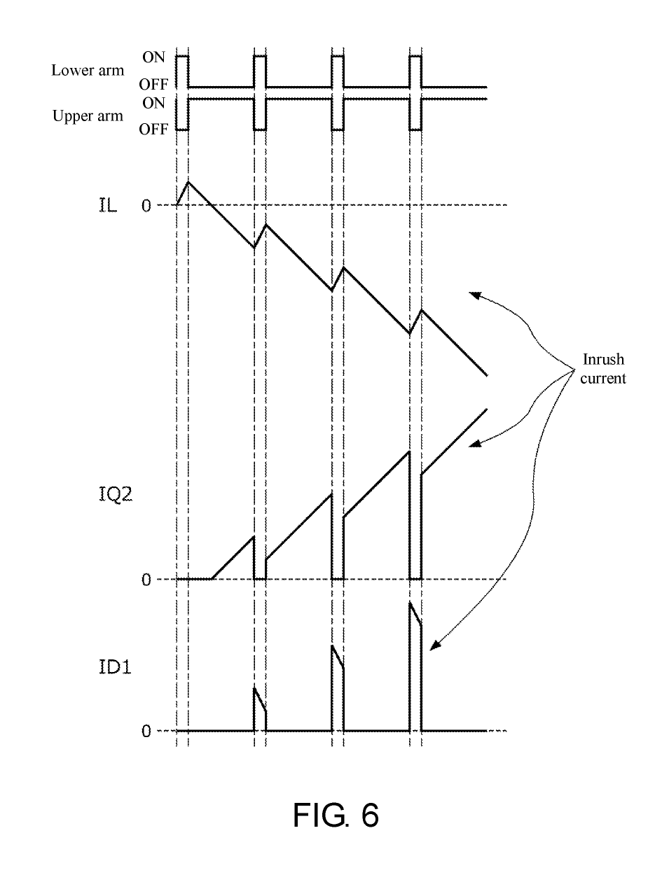

In the case where a determination result in step S2 is YES, i.e., if the primary-side voltage V1 immediately before startup of the VCU 3 is lower than the secondary-side voltage V2, in order to suppress the occurrence of inrush current as explained with reference to FIG. 5 and FIG. 6, the ECU 5 executes a startup control including steps S3 to S8 and then transitions to a normal control in step S9. In addition, in the case where the determination result in step S2 is NO, i.e., if the primary-side voltage V1 immediately before startup of the VCU 3 is equal to or higher than the secondary-side voltage V2, the ECU 5 determines that there is no possibility of occurrence of inrush current even if the above startup control is not executed, and moves to step S9 to directly start the normal control.

In step S9, the ECU 5 executes the normal control of the VCU 3. In this normal control, the ECU 5 complementarily drives the transistor Q1 of the lower arm 31 and the transistor Q2 of the upper arm 32. Herein, complementarily driving the transistors Q1 and Q2 specifically means turning on/off the transistor Q1 under a predetermined duty ratio γ1 [%] and turning off the transistor Q2 while the transistor Q1 is on and turning on the transistor Q2 while the transistor Q1 is off. Herein, the duty ratio γ1 of the transistor Q1 is expressed as γ1=t1/T×100 in the case where a duty cycle is set as T [sec], and a period during the duty cycle T during which the transistor Q1 is on is set as t1 [sec]. In addition, in this normal control, a duty ratio γ2 [%] of the transistor Q2 is expressed by 100-γ1 using the duty ratio γ1.

In addition, at the beginning of the normal control, the ECU 5 sets the duty ratio γ1 of the transistor Q1 to an initial value set to a value slightly greater than 0, and then gradually increases the duty ratio γ1 at a predetermined rate toward a target ratio (e.g., V1−V1/V2_cmd) set based on the target secondary voltage V2_cmd and the primary-side voltage V1. In addition, besides gradually increasing the duty ratio γ1, the ECU 5 sets the duty ratio γ2 of the transistor Q2 to an initial value set to a value slightly smaller than 100 and gradually decreases the duty ratio γ2 from the initial value toward a target ratio (e.g., 1−V1+V1/V2_cmd) at a predetermined rate. In the normal control, the ECU 5 generates the gate driving signals P1 and P2 so as to realize the duty ratios γ1 and γ2 as described above, and controls the secondary-side voltage V2 to be the target secondary voltage V2_cmd by turning on/off the transistors Q1 and Q2 under the gate driving signals P1 and P2.

On the other hand, in the case where the determination result in step S2 is YES and it is determined to execute the startup control before starting the above normal control, the ECU 5 sets the duty ratio γ2 of the transistor Q2 of the upper arm 32 to 0 [%] (see step S3).

Next, in step S4, the ECU 5 sets the duty ratio γ1 of the transistor Q1 of the lower arm 31 to an initial value d [%] set to a value slightly greater than 0.

Next, in step S5, the ECU 5 generates the gate driving signal P1 so as to realize a current set value of the duty ratio γ1, and turns on/off the transistor Q1 over the predetermined duty cycle T under the gate driving signal P1. Moreover, since the duty ratio γ2 of the transistor Q2 is set to 0 as described above, the ECU 5 maintains the transistor Q2 in the off state while the startup control is being executed. For this reason, while the startup control is being executed, even if the secondary-side voltage V2 is higher than the primary-side voltage V1, occurrence of inrush current in a direction from the side of the second power supply 2 toward the side of the first power supply 1 can be suppressed.

Next, in step S6, by using the reactor current IL detected by the current sensor 35 in the current duty cycle, the ECU 5 discriminates whether or not a time to terminate the startup control has arrived, i.e., whether or not a time at which no inrush current will occur even if the ECU 5 terminates the startup control and transitions to the normal control has arrived. In the case where the discrimination in step S6 is NO and it is determined that the time to terminate the startup control has not arrived, to continue with the startup control, the ECU 5 increases the duty ratio γ1 of the transistor Q1 by a predetermined amount Δ[%] set to a value slightly greater than 0 (see step S7), turns on/off the transistor Q1 under the duty ratio γ1 (see step S5), and discriminates again whether or not the time to terminate the startup control has arrived (see step S6). As described above, in the startup control, the ECU 5 discriminates whether or not the time to terminate the startup control has arrived for each duty cycle T while gradually increasing the duty ratio γ1 of the transistor Q1 of the lower arm 31 in the state in which the transistor Q2 of the upper arm 32 is turned off.

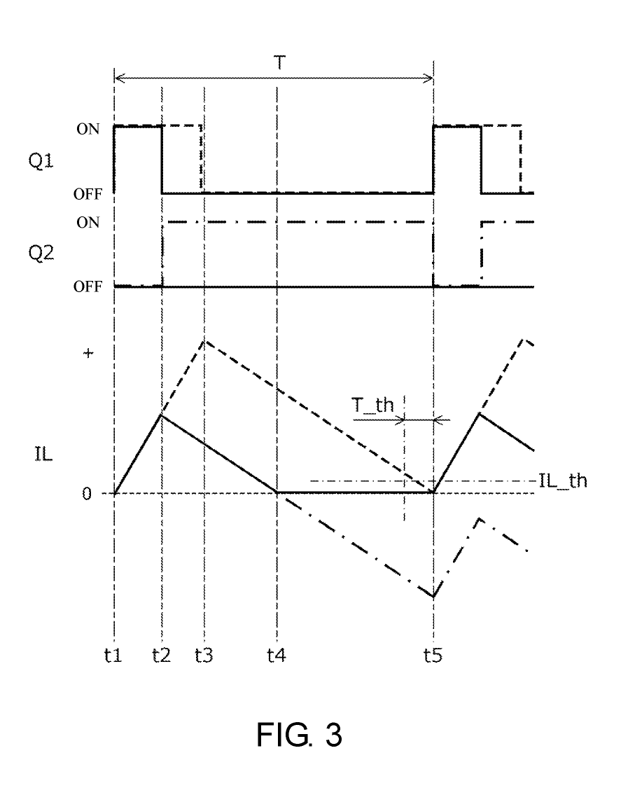

Herein, a specific procedure for discriminating whether or not the time to terminate the startup control has arrived by using the reactor current IL is explained with reference to FIG. 3.

FIG. 3 illustrates a specific example of a change in the reactor current IL during execution of a startup control. Moreover, in FIG. 3, the case where the duty ratio γ1 of the transistor Q1 is set to a predetermined value a is shown in solid line, and the case where the duty ratio γ1 is set to a predetermined value b greater than the predetermined value a is shown in broken line. In addition, the case where the transistor Q2 is driven complementarily to the transistor Q1 similarly as in the normal control is shown in dot-and-dash line. In addition, in FIG. 3, time t1 to time t5 are one duty cycle.

As shown by solid line in FIG. 3, at time t1, when the transistor Q1 is turned from off to on, the reactor current IL starts to increase in the positive direction. After that, at time t2, when the transistor Q1 is turned from on to off, the reactor current IL starts to decrease, and decreases to 0 at time t4. In addition, in the startup control, since the transistor Q2 of the upper arm 32 is maintained in the off state, the reactor current IL is 0 from time t4 until time t5 being the beginning of a next duty cycle.

Herein, as shown by dot-and-dash line in FIG. 3, at time t4, when the transistor Q1 is turned off and the transistor Q2 is turned on, since a current flows from the side of the second power supply 2 having a higher potential toward the side of the first power supply 1, the reactor current IL starts to increase in the negative direction. This means that, in the state in which the duty ratio γ1 of the transistor Q1 is set to the predetermined value a, when the process transitions from the startup control to the normal control, and the transistors Q1 and Q2 start to be complementarily driven, there is a risk that inrush current may occur in the negative direction. That is, this means that the time to terminate the startup control has not arrived.

Meanwhile, as shown by broken line in FIG. 3, the duty ratio γ1 is set to the predetermined value b, and when the transistor Q1 is turned on over a longer time (time t1 to time t3) than in the case where the duty ratio γ1 is set to the predetermined value a, the reactor current IL increases to a greater value than in the case where the duty ratio γ1 is set to the predetermined value a. In addition, at time t3, when the transistor Q1 is turned off, the reactor current IL starts to decrease, and the reactor current IL decreases to around 0 at time t5 being the beginning of the next duty cycle. Accordingly, in the case where the duty ratio γ1 is set to the predetermined value b, the reactor current IL is always maintained at a value equal to or greater than 0 over one duty cycle. In this case, unlike the case where the duty ratio γ1 is set to the predetermined value a, it can be determined that there is no possibility of occurrence of inrush current even if the process transitions to the normal control. That is, this means that the time to terminate the startup control has arrived.

By considering the characteristics of the reactor current IL as described above and using the value of the reactor current IL detected by the current sensor 35 during execution of the startup control, the ECU 5 determines whether or not the time to terminate the startup control has arrived. More specifically, considering that there is an error in the detected value of the current sensor 35, in a target duty cycle, if a length of a period during which the value of the reactor current IL detected by the current sensor 35 is equal to or less than a current threshold IL_th set to 0 or a value slightly greater than 0 is equal to or less than a time threshold T_th set to a value slightly greater than 0, the ECU 5 determines to terminate the startup control.

In addition, as shown in FIG. 3, in the startup control, the reactor current IL tends to reach the peak immediately after the transistor Q1 is turned off and decrease toward 0 after that. Therefore, in the case where the value of the reactor current IL detected by the current sensor 35 is greater than the above current threshold IL_th at the end (time t5 in the example of FIG. 3) of the target duty cycle, the ECU 5 may determine to terminate the startup control. Moreover, in the case of making a determination by this method, it is preferred to set the current threshold IL_th to a value slightly greater than 0, considering that there is an error in the detected value of the current sensor 35.

Back to FIG. 2, if determining in step S6 that the time to terminate the startup control has arrived, the ECU 5 moves to step S8 to transition to the normal control. In step S8, the ECU 5 sets the initial values of the duty ratios γ1 and γ2 of the transistors Q1 and Q2 in the normal control which starts in the next step. The ECU 5 continues to adopt the value of the duty ratio γ1 at the present moment (i.e., the moment at which it is determined to terminate the startup control) as the initial value of the duty ratio γ1 in the normal control. In addition, the ECU 5 sets the initial value of the duty ratio γ2 in the normal control based on the value of the duty ratio γ1 at the present moment. More specifically, the ECU 5 sets a value obtained by subtracting the duty ratio γ1 at the present moment from 1 as the initial value of the duty ratio γ2 in the normal control (γ2=1−γ1). After that, the ECU 5 starts the normal control of the VCU 3 as described above under the initial values of the duty ratios γ1 and γ2 set as above.

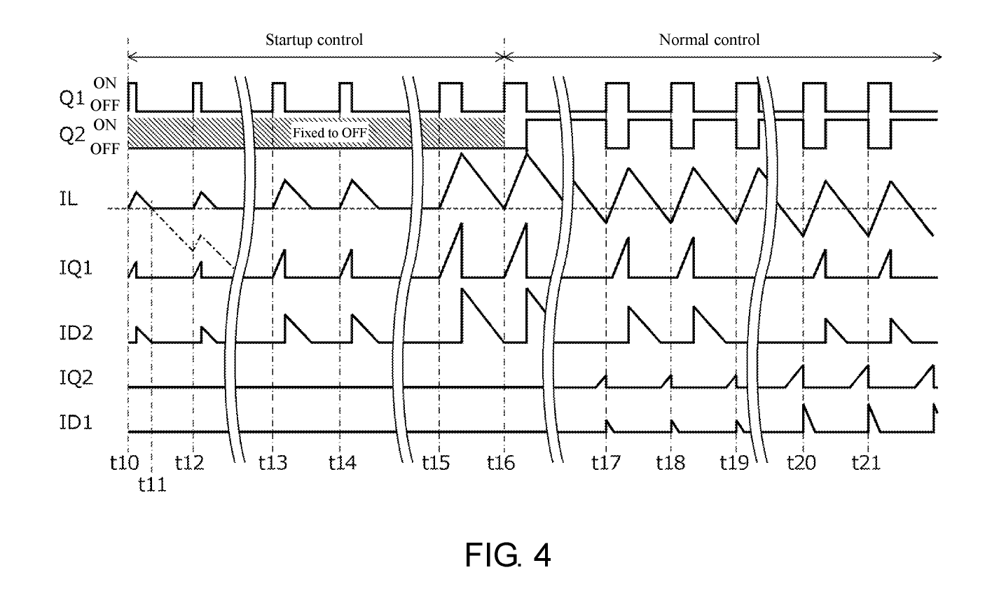

FIG. 4 is a time chart showing changes in various currents realized in the case where the VCU 3 is started according to the flowchart of FIG. 2. FIG. 4 shows a control example in the case where the primary-side voltage V1 immediately before startup of the VCU 3 is lower than the secondary-side voltage V2. More specifically, a case is shown where, after the startup control (steps S3 to S8 in FIG. 2) is performed from time t10 to time t16, the process transitions to the normal control (step S9 in FIG. 2) from time t16.

In addition, FIG. 4 shows, in sequence from the upper section, the transistor Q1 of the lower arm 31, the transistor Q2 of the upper arm 32, the reactor current IL (a direction from the primary positive electrode terminal 11 toward the connection midpoint 33 is defined as positive direction), a current IQ1 (a direction from the collector toward the emitter of the transistor Q1 is defined as positive direction) flowing through the transistor Q1 of the lower arm 31, a current ID2 (a forward direction of the diode D2 is defined as positive direction) flowing through the antiparallel diode D2 of the upper arm 32, a current IQ2 (a direction from the collector toward the emitter of the transistor Q2 is defined as positive direction) flowing through the transistor Q2 of the upper arm 32, and a current ID1 (a forward direction of the diode D1 is defined as positive direction) flowing through the antiparallel diode D1 of the lower arm 31.

In the startup control during time t10 to time t16, while maintaining the transistor Q2 of the upper arm 32 in the off state, the ECU 5 turns on-off the transistor Q1 under the duty ratio γ1 of the transistor Q1 of the lower arm 31 while increasing the duty ratio γ1 from around 0 by the predetermined amount Δ at a time per duty cycle. That is, as shown in FIG. 4, an on-duty period of the transistor Q1 gradually becomes longer.

In addition, in the startup control during time t10 to time t16, since the transistor Q2 of the upper arm 32 is maintained in the off state, the current IQ2 flowing through the transistor Q2 is 0. In addition, since the diode D1 of the lower arm 31 is also in a reverse biased state, the current ID1 flowing through the diode D1 is also 0.

Herein, the changes in various currents realized in the startup control are explained by focusing on the first duty cycle during time t10 to time t12. First of all, when the transistor Q1 is turned on from time t10 and over the on-duty period set in accordance with the duty ratio γ1 at that moment, the reactor current IL flows as the current IQ1 of the transistor Q1 so as to increase in the positive direction. The current IQ1 reaches the peak at the end of the on-duty period. Then, at the end of the on-duty period of the transistor Q1, when the transistor Q1 is turned off, the reactor current IL in the positive direction flows as the current ID2 of the diode D2 while decreasing toward 0.

After that, at time t11, the flowing of the reactor current IL in the positive direction decreases to reach 0. Herein, since the transistor Q2 is maintained in the off state, even if there is a difference between the primary-side voltage V1 and the secondary-side voltage V2, the reactor current IL is maintained at 0 to the end (time t12) of the first duty cycle without flowing in the negative direction.

Herein, in FIG. 4, the reactor current IL realized in the case where the transistor Q2 is driven complementarily to the transistor Q1 is shown by a dot-and-dash line. As shown by this dot-and-dash line, if the transistor Q2 is turned on at time t11, since a passage of the reactor current IL in the negative direction is ensured, the reactor current IL starts to increase in the negative direction. Hence, if the startup control is terminated at time t12 and the process transitions to the normal control, it is conceivable that inrush current may occur.

Moreover, in the second duty cycle (after time t12), the third duty cycle (from time t13 to time t14), the fourth duty cycle (after time t14), and the fifth duty cycle (from time t15 to time t16), the transistor Q1 is turned on/off while the duty ratio γ1 of the transistor Q1 is being gradually increased (see step S7 in FIG. 2). Hence, the reactor current IL, the current IQ1 of the transistor Q1, and the current ID2 of the diode D2 qualitatively show the same behavior as the first duty cycle (from time t10 to time t12) while their peak values are increased.

In addition, in the fifth duty cycle (from time t15 to time t16), in response to the fact that the duty ratio γ1 of the transistor Q1 is increased to a proper magnitude, the length of the period during which the value of the reactor current IL is equal to or less than the current threshold IL_th is equal to or less than the time threshold T_th. According to this, the ECU 5 determines that no inrush current will occur even if the process transitions to the normal control from the next duty cycle, terminates the startup control, and starts the normal control (see S6 in FIG. 2) after the sixth duty cycle (after time t16).

In the normal control, the ECU 5 turns on/off the transistors Q1 and Q2 in a mutually complementary manner. In addition, in the sixth duty cycle (after time t16), i.e., the initial duty cycle after the transition to the normal control, the ECU 5 starts on/off driving (see step S8 in FIG. 2) by using the duty ratio γ1 in the duty cycle (i.e., the fifth duty cycle) during which it is determined to terminate the startup control as the initial value of the duty ratio γ1 of the transistor Q1. In addition, the on/off driving (see step S8 in FIG. 2) is started by using a value set based on the duty ratio in the duty cycle during which it is determined to terminate the startup control as the initial value of the duty ratio γ2 of the transistor Q2. In this way, at transition from the startup control to the normal control, the duty ratio γ1 of the transistor Q1 has been increased to a proper magnitude. Thus, no inrush current occurs.

In addition, in the seventh duty cycle (from time t17 to time t18), the eighth duty cycle (from time t18 to time t19), and the ninth duty cycle (from time t20 to time t21) thereafter, the ECU 5 gradually increases the duty ratio γ1 of the transistor Q1 to a target ratio so as to eventually realize the target secondary voltage V2_cmd. In addition, meanwhile, the duty ratio γ2 of the transistor Q2 is gradually decreased to a target ratio so as to eventually realize the target secondary voltage V2_cmd.

According to the power supply system S of the present embodiment, the following effects are achieved.

(1) In the power supply system S, at startup of the VCU 3, after the startup control that gradually increases the duty ratio γ1 of the transistor Q1 of the lower arm 31 in the state in which the transistor Q2 of the upper arm 32 is turned off is performed, the normal control that complementarily drives the transistor Q2 of the upper arm 32 and the transistor Q1 of the lower arm 31 is performed. Herein, while the startup control is being performed, since the transistor Q2 of the upper arm 32 is maintained off, even if the secondary-side voltage V2 is higher than the primary-side voltage V1, the occurrence of inrush current from the side of the second power supply 2 toward the side of the first power supply 1 can be suppressed. In the power supply system S, whether to terminate the startup control in execution and transition to the normal control or to continue with the startup control in execution is determined using the value of the reactor current IL detected by the current sensor 35 in the process during which the duty ratio γ1 of the lower arm 31 is gradually increased by the startup control. Accordingly, in the power supply system S, the startup control can be terminated and the process can transition to the normal control at a proper timing corresponding to a difference between the primary-side voltage V1 and the secondary-side voltage V2 at that moment, i.e., in the state in which the duty ratio γ1 of the lower arm 31 is increased to a proper magnitude corresponding to the above voltage difference under the startup control. Thus, the occurrence of inrush current at transition to the normal control can be suppressed. In addition, in the power supply system S, by using the value of the reactor current IL detected by the current sensor 35, without adjusting a threshold using a difference between the voltages V1 and V2, the time to terminate the startup control can be decided at a proper timing each time.

(2) Herein, in the startup control, when the duty ratio γ1 of the transistor Q1 of the lower arm 31 is gradually increased, a time at which the current flowing through the reactor L decreases to 0 after the transistor Q1 of the lower arm 31 is turned off in each duty cycle is delayed. Accordingly, in each duty cycle, the length of the period during which the value of the reactor current IL acquired by the current sensor 35 is equal to or less than the current threshold IL_th is suitable as a parameter for determining whether to terminate or to continue with the startup control. In the power supply system S, in the case where the length of such period is equal to or less than the time threshold T_th set to a value slightly greater than 0, it is determined to terminate the startup control. Accordingly, the startup control can be terminated at a proper timing so that no inrush current occurs at transition to the normal control.

(3) In the power supply system S, if the value of the reactor current IL detected by the current sensor 35 at the end of the duty cycle of the transistor Q1 of the lower arm 31 is greater than the current threshold IL_th set to a value slightly greater than 0, it is determined to terminate the startup control. Accordingly, even if detection accuracy of the current sensor 35 is taken into consideration, the reactor current IL flowing through the reactor L will not increase in the negative direction immediately after the transition to normal control. Thus, inrush current can be more reliably suppressed. Moreover, in this case, there is an advantage that, since the time to terminate the startup control is determined using the value of the reactor current IL acquired at the end of the duty cycle, operation load is reduced as compared to the case where the time to terminate the startup control is determined by monitoring a history of the value of the reactor current IL as described above.

(4) In the power supply system S, as the current sensor 35, one generating a signal corresponding to a current flowing between the primary positive electrode terminal 11 connected to the primary smoothing capacitor C1 and the reactor L or between the reactor L and the connection midpoint 33 is used. Accordingly, since the value of the reactor current IL flowing through the reactor L can be accurately acquired, the startup control can be terminated at a proper timing so that no inrush current occurs at the transition to the normal control.

(5) In the power supply system S, based on the duty ratio γ1 of the transistor Q1 of the lower arm 31 in the duty cycle during which it is determined to terminate the startup control, the duty ratio γ2 of the transistor Q2 of the upper arm 32 in the normal control is set. Accordingly, the occurrence of inrush current immediately after the transition to the normal control can be more reliably suppressed.

The above has explained one embodiment of the disclosure, but the disclosure is not limited thereto. Details of the construction may be properly changed within the scope of spirit of the disclosure.

What is claimed is:

1. A power supply system, comprising:
a first power supply;
a second power supply;
a voltage converter having an input terminal connected to the first power supply and an output terminal connected to the second power supply, the voltage converter stepping up and outputting a voltage from the input terminal to the output terminal; and
a control device controlling the voltage converter, wherein
the voltage converter comprises:
an upper arm comprising a switching element having one end connected to a positive electrode of the output terminal;
a lower arm comprising a switching element having one end connected to the upper arm and the other end connected to a negative electrode of the output terminal;
a reactor having one end connected to a positive electrode of the input terminal and the other end connected to a connection midpoint between the upper arm and the lower arm; and
a reactor current acquisition part acquiring a value of a current flowing in the reactor;
at startup of the voltage converter, the control device performs a startup control that gradually increases a duty ratio of the switching element of the lower arm in a state in which the switching element of the upper arm is turned off, then performs a normal control that complementarily drives the switching element of the upper arm and the switching element of the lower arm, and during execution of the startup control, determines whether to terminate or to continue with the startup control by using the value of the current acquired by the reactor current acquisition part.

2. The power supply system according to claim 1, wherein if a length of a period during which the value of the current acquired by the reactor current acquisition part is equal to or less than a current threshold set to 0 or a value slightly greater than 0 is equal to or less than a time threshold set to a value slightly greater than 0 in a duty cycle of the switching element of the lower arm, the control device determines to terminate the startup control.

3. The power supply system according to claim 1, wherein if the value of the current acquired by the reactor current acquisition part at the end of a duty cycle of the switching element of the lower arm is greater than a current threshold set to a value slightly greater than 0, the control device determines to terminate the startup control.

4. The power supply system according to claim 1, wherein the voltage converter comprises a smoothing capacitor connected to the positive electrode and a negative electrode of the input terminal, and
the reactor current acquisition part is a current sensor that generates a signal corresponding to a current flowing between the positive electrode of the input terminal and the reactor or between the reactor and the connection midpoint.

5. The power supply system according to claim 1, wherein the control device sets a duty ratio of the switching element of the upper arm in the normal control based on the duty ratio of the switching element of the lower arm in the duty cycle during which it is determined to terminate the startup control.

6. The power supply system according to claim 2, wherein the voltage converter comprises a smoothing capacitor connected to the positive electrode and a negative electrode of the input terminal, and
the reactor current acquisition part is a current sensor that generates a signal corresponding to a current flowing between the positive electrode of the input terminal and the reactor or between the reactor and the connection midpoint.

7. The power supply system according to claim 3, wherein the voltage converter comprises a smoothing capacitor connected to the positive electrode and a negative electrode of the input terminal, and
the reactor current acquisition part is a current sensor that generates a signal corresponding to a current flowing between the positive electrode of the input terminal and the reactor or between the reactor and the connection midpoint.

8. The power supply system according to claim 2, wherein the control device sets a duty ratio of the switching element of the upper arm in the normal control based on the duty ratio of the switching element of the lower arm in the duty cycle during which it is determined to terminate the startup control.

9. The power supply system according to claim 3, wherein the control device sets a duty ratio of the switching element of the upper arm in the normal control based on the duty ratio of the switching element of the lower arm in the duty cycle during which it is determined to terminate the startup control.

10. The power supply system according to claim 4, wherein the control device sets a duty ratio of the switching element of the upper arm in the normal control based on the duty ratio of the switching element of the lower arm in the duty cycle during which it is determined to terminate the startup control.

11. The power supply system according to claim 6, wherein the control device sets a duty ratio of the switching element of the upper arm in the normal control based on the duty ratio of the switching element of the lower arm in the duty cycle during which it is determined to terminate the startup control.

12. The power supply system according to claim 7, wherein the control device sets a duty ratio of the switching element of the upper arm in the normal control based on the duty ratio of the switching element of the lower arm in the duty cycle during which it is determined to terminate the startup control.
